(19) United States
(12) Patent Application Publication
(10) Pub. No.: US 2007/0263988 A1
(43) Pub. Date: Nov. 15, 2007

(54) RECORDING APPARATUS AND RECORDING METHOD

(75) Inventor: Kengo Takeuchi, Yokohama-shi, (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/744,371

(22) Filed: May 4, 2007

(30) Foreign Application Priority Data
May 9, 2006 (JP) 2006-130099
Apr. 10, 2007 (JP) 2007-103092

(51) Int. Cl. H04N 5/91

(52) U.S. Cl. 386/107

(57) ABSTRACT

A recording apparatus includes a recording format selection unit configured to select one of a plurality of recording formats, an initialization unit configured to initialize a loaded recording medium, a recording unit configured to record image data on the loaded recording medium, and a mode switching unit configured to switch between an ordinary recording mode that enables the initialization unit to initialize a newly loaded recording medium based on a recording format selected by the selection unit independent of a recording format selected for a preceding recording medium and a relay recording mode that enables the initialization unit to initialize a newly loaded recording medium, if loaded after a preceding recording medium, based on a recording format selected for the preceding recording medium.

### BACKGROUND OF THE INVENTION

1. Field of the Invention

The present invention relates to a recording apparatus and a recording method. More particularly, the present invention relates to a technique for continuously recording image signals on plural recording media.

2. Description of the Related Art

Video cameras can capture a moving image of an object and record/playback the captured image on/from a magnetic tape, a memory card, or an optical disk. Disk video cameras have recording/playback capability applicable to a digital versatile disk (DVD). For example, a video camera can use a DVD-recordable (DVD-R) which is a write-once disk, a DDVD-rewritable (DVD-RW) which is a rewritable disk, and a DVD-random access memory (DVD-RAM).

The logic format presently proposed for recording image data on a DVD is DVD-Video format or DVD Video Recording (VR) format that can be selected depending on the type of each disk For example, a video camera selects the DVD-Video format for recording on a DVD-R and selects the VR format for recording on a DVD-RAM. Furthermore, a video camera can select either the DVD-Video format or the VR format for recording on a DVD-RW.

Hence a video camera, if a disk is newly loaded, identifies the type of the newly loaded disk. If the newly loaded disk is a DVD-RW disk, a user can select a recording format between the DVD-Video mode and the VR mode. The video camera performs format processing for a newly loaded disk based on a selected recording format (refer to Japanese Patent Application Laid-Open No. 2003-178445).

The DVD presently usable for a video camera has a recording capacity equal to approximately 1.4 GB and has the capability of recording 20 to 30 minutes of image and audio data at a standard quality mode (at a recording rate equal to approximately 6 Mbps).

A user, when recording moving images for a long time, frequently interrupts the shooting (image pickup) operation to exchange the disks. The disk exchanging operation includes, in addition to the aforementioned disk recognition and the format processing, processing for optimizing the power of a light beam. Thus, the disk exchanging operation takes a long time.

A video camera performs initialization processing if a newly loaded disk is a brand-new disk (i.e., a disk having not yet been used for recording image data). In particular, if a recording format for the disk is selectable between the DVD-Video format and the VR format, a user is required to designate a desirable recording format each time a new disk is loaded.

The aforementioned complicated recording format selecting operation is troublesome for a user who wants to quickly accomplish the exchange of disks and immediately start a shooting operation.

### SUMMARY OF THE INVENTION

Exemplary embodiments of the present invention are directed to a recording apparatus capable of simplifying selection of a recording format for a newly loaded disk, if loaded after a preceding disk to continuously record image data, when plural recording formats are selectable.

According to an aspect of the present invention, a recording apparatus includes a recording format selection unit configured to select one of a plurality of recording formats, an initialization unit configured to initialize a loaded recording medium based on a recording format selected by the recording format selection unit, a recording unit configured to record image data on the loaded recording medium, a storage unit configured to store a recording format type of the loaded recording medium, and a control unit configured to control the initialization unit to initialize a newly loaded recording medium, if loaded after a preceding recording medium, based on a recording format type of the preceding recording medium stored in the storage unit and to control the recording unit to record image data on the initialized recording medium based on the recording format type of the preceding recording medium stored in the storage unit.

According to another aspect of the present invention, a recording apparatus includes a recording format selection unit configured to select one of a plurality of recording formats, an initialization unit configured to initialize a loaded recording medium, a recording unit configured to record image data on the loaded recording medium, and a mode switching unit configured to switch between an ordinary recording mode that enables the initialization unit to initialize a newly loaded recording medium based on a recording format selected by the selection unit independent of a recording format selected for a preceding recording medium and a relay recording mode that enables the initialization unit to initialize a newly loaded recording medium, if loaded after a preceding recording medium, based on a recording format selected for the preceding recording medium.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a video camera according to an exemplary embodiment.

FIG. 2 is a flowchart illustrating an exemplary operation of the video camera in a relay recording mode.

FIG. 3 is a flowchart illustrating an exemplary order information recording operation.

FIGS. 4A and 4B illustrate exemplary recording states of plural disks recorded according to the relay recording mode.

FIG. 5 illustrates various messages displayed on a display unit of the video camera according to an exemplary embodiment.

FIG. 6 illustrates title menus for plural disks generated according to an exemplary embodiment.

FIG. 7 is a flowchart illustrating exemplary preparation processing.

FIG. 8 illustrates an example of order information.

FIG. 9 is a flowchart illustrating an exemplary recording operation.

FIG. 10 is a flowchart illustrating exemplary processing performed by the video camera in an ordinary recording mode.

FIG. 11 is a flowchart illustrating an exemplary preparation operation of the video camera in the ordinary recording mode.

### DETAILED DESCRIPTION OF THE EMBODIMENTS

The following description of exemplary embodiments is merely illustrative in nature and is in no way intended to limit the invention, its application, or uses.

Processes, techniques, apparatus, and systems as known by one of ordinary skill in the art may not be discussed in detail but are intended to be part of the enabling description where appropriate.

For example, certain circuitry for image processing, data processing, and other uses may not be discussed in detail. However these systems and the methods to fabricate these system as known by one of ordinary skill in the relevant art is intended to be part of the enabling disclosure herein where appropriate.

It is noted that throughout the specification, similar reference numerals and letters refer to similar items in the following figures, and thus once an item is described in one figure, it may not be discussed for following figures.

Exemplary embodiments will be described in detail below with reference to the drawings.

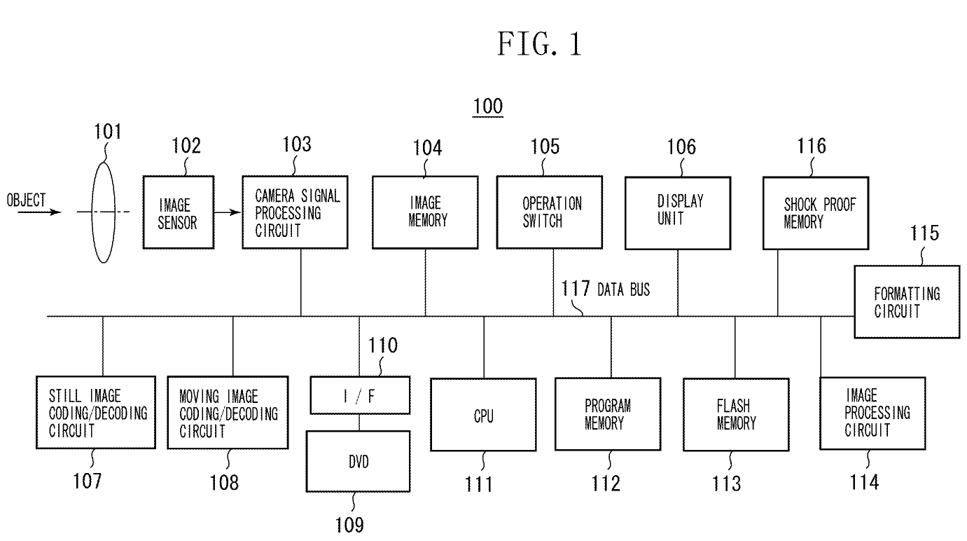

FIG. 1 is a block diagram illustrating an exemplary configuration of a camera-integrated moving image recording/playback apparatus (video camera) 100. When the video camera 100 starts an operation, a compressed program in a flash memory 113 is decompressed and expanded in a program memory 112. A central processing unit (CPU) 111 executes various control operations according to the program stored in the program memory 112.

Light from an object, after passing through a lens unit 101, can be captured by an image sensor (or image pickup element) 102. The image sensor 102 converts an object image (i.e., an optical signal) into an electric signal. A camera signal processing circuit 103 reads a photoelectric conversion image from the image sensor 102 at predetermined intervals.

The camera signal processing circuit 103 can apply predetermined processing to the read signal and obtain a standard image signal. An image memory 104 temporarily stores a standard digital moving image resulting from the signal processing performed by the camera signal processing circuit 103.

The camera signal processing circuit 103 sends a digital moving image to a display unit 106. The display unit 106 can display a moving image of an object that is currently captured by a user (hereinafter, referred to as “shooting standby state”). The shooting standby state allows a user to start a shooting (image pickup) operation if the user presses a shooting button (not shown) included in an operation switch 105.

When a shooting operation starts, a moving image coding/decoding circuit 108 encodes the moving image data temporarily stored in the image memory 104 and sends the encoded moving image data to a formatting circuit 115. The formatting circuit 115 converts the encoded moving image data into recording data having a suitable DVD format and sends the recording data to a shock proof memory 116. If a predetermined amount of data is stored in the shock proof memory 116, an interface (I/F) 110 reads the data from the shock proof memory 116 and records the read data onto a DVD 109.

If the shooting button involved in the operation switch 105 is pressed again by a user, the video camera 100 stops recording data. Thus, the video camera 100 terminates recording of a moving image clip which can be referred to as “one-cut.”

If a user presses a still image shooting button during the above-described shooting standby state, moving image data corresponding to one picture is sent from the image memory 104 to a still image coding/decoding circuit 107. The still image coding/decoding circuit 107 encodes the received image data as a still image and sends the encoded still image to the shock proof memory 116. The I/F 110 can read the still image data from the shock proof memory 116 and record the read still image data on the DVD 109. As illustrated in FIG. 1, the video camera 100 further includes an image processing circuit 114 and a data bus 117.

The operation switch 105 allows a user to arbitrarily select a desirable image quality for a moving image to be recorded because the video camera 100 provides plural image quality modes beforehand. In the present embodiment, a user can select one of two image quality modes (i.e., a standard quality mode and a high quality mode). The data rate for recording moving image data is lower in the standard quality mode compared to that in the high quality mode.

Therefore, compared to the high quality mode, the standard quality mode can provide a longer time for recording moving images on a disk. The flash memory 113 is capable of storing information relating to the set image quality mode, even after the power source is turned off.

In the present embodiment, the DVD 109 is a DVD-RW type and the recording format is DVD-Video format or DVD Video Recording (VR) format. An ejection mechanism (not shown) enables a user to load or unload a disk to or from the video camera 100.

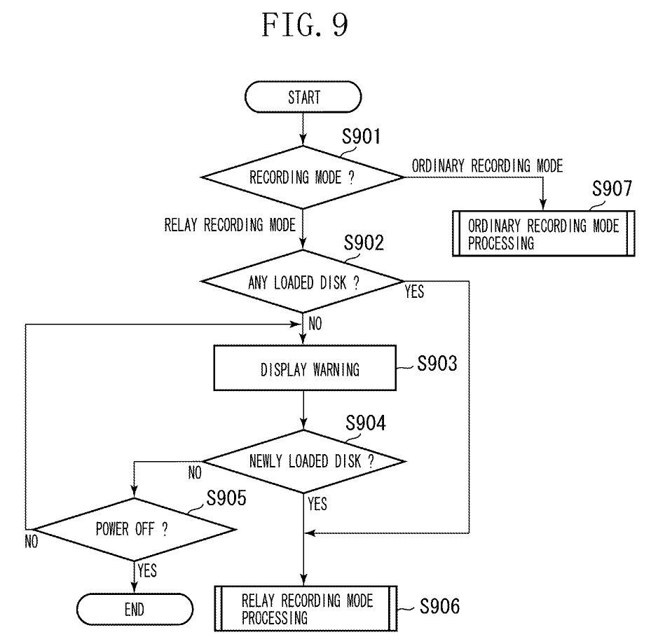

Next, an exemplary operation of the video camera 100 is described. FIG. 9 is a flowchart illustrating a control operation of the CPU 111 performed when the power source is turned on.

In step S901, in response to the turning-on operation of the power source, the CPU 111 detects a currently set recording mode. The video camera 100 according to the present embodiment can operate in a relay recording mode in addition to an ordinary recording mode. In the relay recording mode for recording sequential images of an event on plural disks, the video camera 100 enables a user to shorten a preparation time for exchanging disks and promptly start a shooting operation.

Furthermore, the video camera 100 according to the present embodiment can manage plural disks recorded according to the relay recording mode as belonging to a same group. Moreover, after a shooting operation is completed, the video camera 100 can record order information indicating the order of each disk in the group and a total number of disks belonging to the same group.

If the CPU 111 determines that the relay recording mode is currently set, the processing flow proceeds to step S902. In step S902, the CPU 111 determines whether the disk 109 is currently loaded in the video camera 100. If the CPU 111 determines that the disk 109 is already loaded (YES in step S902), the processing flow proceeds to step S906 to cause the video camera 100 to execute processing in the relay recording mode.

If the CPU 111 determines that no disk is loaded (NO in step S902), the processing flow proceeds to step S903. In step S903, the CPU 111 causes the display unit 106 to display warning information that prompts a user to load a disk.

Then, in step S904, the CPU 111 determines whether a disk is newly loaded. If the CPU 111 determines that a disk is newly loaded (YES in step S904), the processing flow proceeds to step S906. In step S906, the video camera 100 performs operations according to the relay recording mode.

If the CPU 111 determines that no disk is newly loaded (NO in step S904), the processing flow proceeds to step S905. In step S905, the CPU 111 determines whether a power-off instruction is input. If the CPU 111 determines that a power-off instruction is input (YES in step S905), the video camera 100 turns the power source off and the CPU 111 terminates the processing of this routine.

If, in step S901, the CPU 111 determines that the ordinary recording mode is currently set, the processing flow proceeds to step S907. In step S907, the video camera 100 performs operations in the ordinary recording mode.

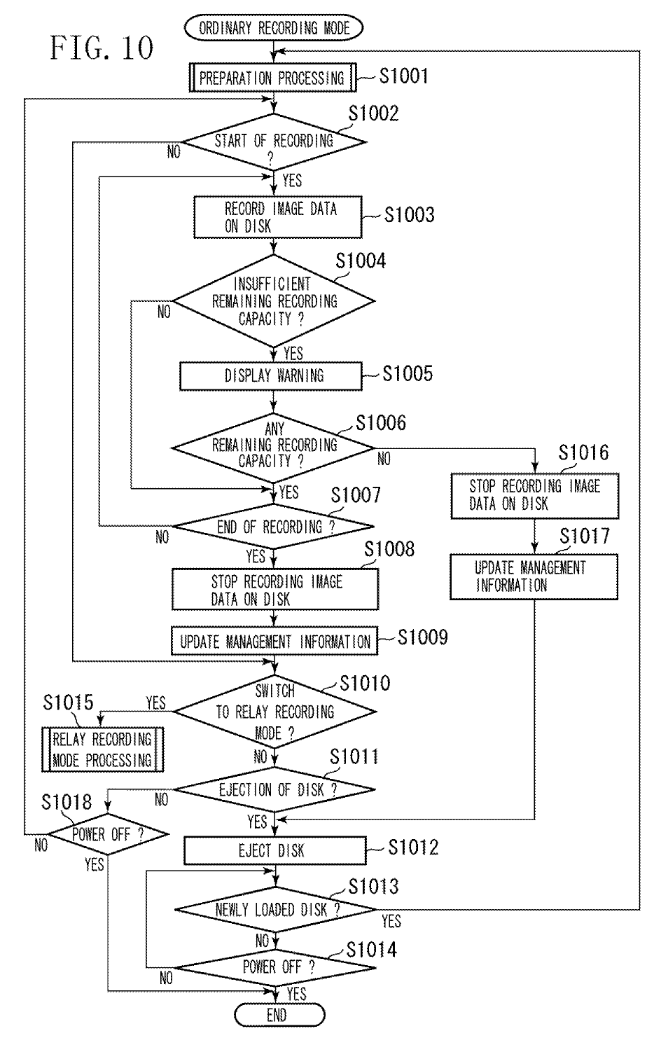

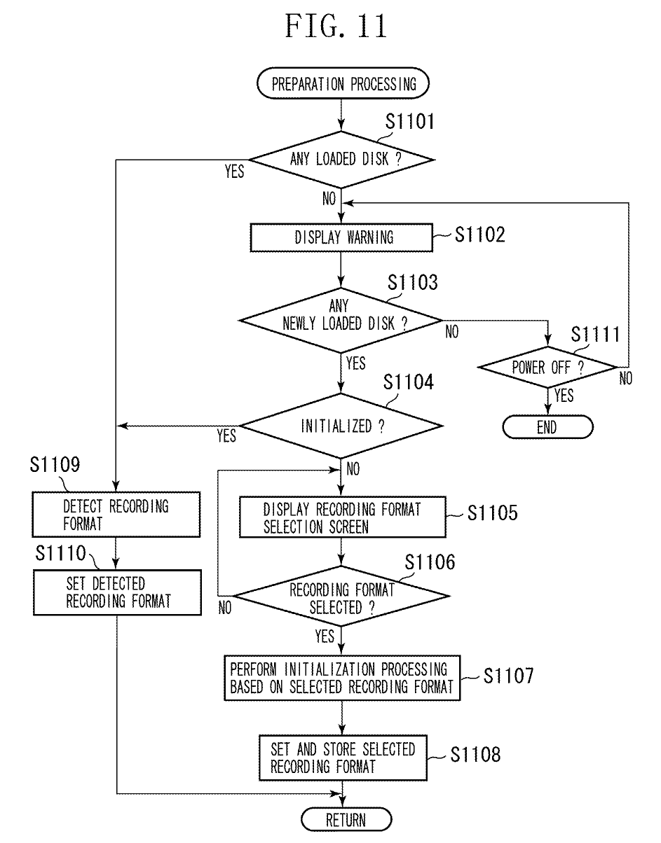

FIG. 10 is a flowchart illustrating exemplary processing performed by the video camera 100 in the ordinary recording mode. In step S1001, the CPU 111 executes preparation processing. FIG. 11 is a flowchart illustrating exemplary preparation processing performed in step S1001. In step S1101, the CPU 111 determines whether the disk 109 is currently loaded. If the disk 109 is already loaded (YES in step S1101), the processing flow proceeds to step S1109.

In step S1109, the CPU 111 detects a recording format of the disk 109 (i.e., DVD-Video format or VR format). Then, in step S1110, the CPU 111 sets the detected recording format. The flash memory 113 stores information relating to the detected recording format. Then, the video camera 100 records the image data on the disk 109 based on the detected recording format.

If no disk is loaded (NO in step S1101), the processing flow proceeds to step S1102. In step S1102, the CPU 111 causes the display unit 106 to display warning information that prompts a user to load a disk. Then, in step S1103, the CPU 111 determines whether a disk is newly loaded. If the CPU 111 determines that no disk is loaded (NO in step S1103), the processing flow proceeds to step S1111.

In step S1111, the CPU 111 determines whether a power-off instruction is input. If the CPU 111 determines a power-off instruction is input (YES in step S1111), the video camera 100 turns the power source off and the CPU 111 terminates the processing of this routine.

If the CPU 111 determines that a disk is newly loaded (YES in step S1103), the processing flow proceeds to step S1104. In step S1104, the CPU 111 detects management information recorded on the disk and determines whether the disk is already initialized (i.e., recorded based on the video format or the VR format, or not yet formatted).

If the CPU 111 determines that the loaded disk is already formatted (i.e., already initialized) (YES in step S1104), the processing flow proceeds to step S1109, in which the CPU 111 detects a recording format of the disk. If the CPU 111 determines that the loaded disk is not yet formatted or initialized (NO in step S1104), the processing flow proceeds to step S1105.

In step S1105, the CPU 111 causes the display unit 106 to display a recording format selection screen. Next, in step S1106, the CPU 111 determines whether a user has selected a recording format (i.e., DVD-Video format or VR format). A user can select the recording format between the DVD-Video format and the VR format via the operation switch 105. If the CPU 111 determines that a recording format is selected by a user (YES in step S1106), the processing flow proceeds to step S1107.

In S1107, the CPU 111 executes initialization processing for the loaded disk (i.e., unformatted or uninitialized disk) based on the recording format designated by a user. Then, in step S1108, the CPU 111 sets the selected recording format and the flash memory 113 stores information relating to the selected recording format.

As described above, the video camera 100 can display the recording format selection screen if an uninitialized disk is loaded in the ordinary recording mode, and enables a user to select a desirable recording format. [0057] Returning to FIG. 10, after the above-described preparation processing, in step S1002, the CPU 111 determines whether a recording start instruction is input via the operation switch 105. If the CPU 111 determines that a recording start instruction is input (YES in step S1002), the processing flow proceeds to step S1003.

In step S1003, the video camera 100 records the generated moving image data on the disk 109 as described above. Namely, the video camera 100 records the moving image data based on the recording format and the image quality mode that have been set in the preparation processing.

In step S1004, the CPU 111 detects a remaining recording capacity of the disk 109 based on the management information recorded on the disk 109. The CPU 111 determines whether the detected remaining recording capacity is equal to or less than a predetermined amount.

The predetermined amount in step S1004 is a data amount corresponding to a predetermined remaining time (i.e., several minutes) recordable on the disk 109 at an image quality mode (data rate) currently selected. Therefore, the predetermined amount in step S1004 is variable depending on the image quality mode. However, the CPU 111 can refer to a constant threshold value regardless of the selected image quality mode, if acceptable, to check the remaining recording capacity of a disk.

If the CPU 111 determines that the remaining recording capacity is equal to or less than the predetermined amount (YES in step S1004), the processing flow proceeds to step S1005. In step S1005, the CPU 111 causes the display unit 106 to display warning information to indicate a situation where the remaining recording capacity is insufficient.

Then, in step S1006, the CPU 111 determines whether the disk 109 has any remaining recording capacity. If the CPU 111 determines that there is any remaining recording capacity (YES in step S1006), the processing flow proceeds to step S1007. In step S1007, the CPU 111 determines whether a recording stop instruction is input via the operation switch 105. If the CPU 111 determines that no recording stop instruction is input (NO in step S1007), the processing flow returns to step S1003 to continue the recording operation. If the CPU 111 determines that a recording stop instruction is input (YES in step S1007), the processing flow proceeds to step S1008.

In step S1008, the video camera 100 stops recording image data on the disk 109. Then, in step S1009, the CPU 111 updates the management information of the disk 109 stored in the flash memory 113. Next, in step S1010, the CPU 111 determines whether a relay recording mode switching instruction is input via the operation switch 105. If the CPU 111 determines that a relay recording mode switching instruction is input (YES in step S1010), the processing flow proceeds to step S1015.

In step S1015, the video camera 100 executes processing according to the relay recording mode. If the CPU 111 determines that no relay recording mode switching instruction is input (NO in step S1010), the processing flow proceeds to step S1011. In step S1011, the CPU 111 determines whether an ejection instruction for the disk 109 is input via the operation switch 105. If the CPU 111 determines that a disk ejection instruction is input (YES in step S1011), the processing flow proceeds to step S1012.

In S1012, the video camera 100 ejects the disk 109. Next, in step S1013, the CPU 111 determines whether a disk 109 is newly loaded. If the CPU 111 determines that a disk 109 is newly loaded (YES in step S1013), the processing flow returns to step S1001 to execute the preparation processing. If the CPU 111 determines that no disk is loaded (NO in step S1013), the processing flow proceeds to step S1014.

In step S1014, the CPU 111 determines whether a power-off instruction is input. If the CPU 111 determines that a power-off instruction is input (YES in step S1014), the CPU 111 stores, in the flash memory 113, the information indicating a state where the video camera 100 is currently operating according to the ordinary recording mode and turns the power source off.

If the CPU 111 determines that no disk ejection instruction is input (NO in step S1011), the processing flow proceeds to step S1018. In step S1018, the CPU 111 determines whether a power-off instruction is input via the operation switch 105. If the CPU 111 determines that a power-off instruction is input (YES in step S1018), the CPU 111 stores, in the flash memory 113, the information indicating a state where the video camera 100 is currently operating according to the ordinary recording mode and turns the power source off.

If in step S1006 the CPU 111 determines that the disk 109 has no remaining recording capacity for recording the image data (NO in step S1006), the processing flow proceeds to step S1016. In step S1016, the video camera 100 stops recording image data on the disk 109. Then, in step S1017, the CPU 111 updates the management information of the disk 109 stored in the flash memory 113. Then, the processing flow proceeds to step S1012 to eject the disk 109.

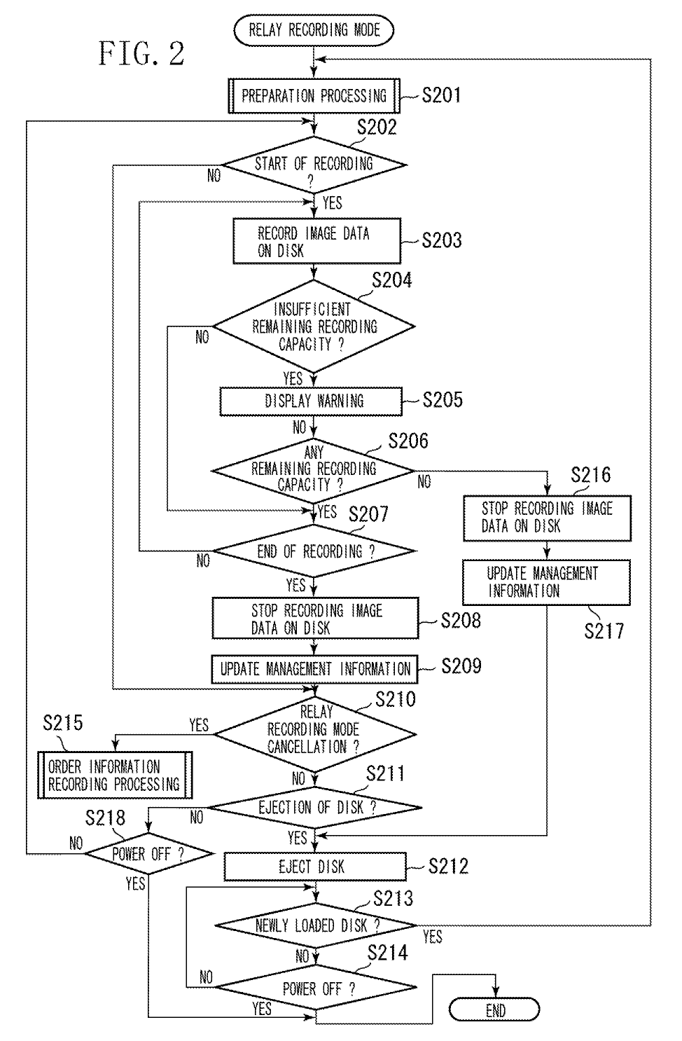

Next, an exemplary relay recording operation of the video camera 100 is described with reference to the flowchart illustrated in FIG. 2.

A user can set the relay recording mode by operating a relay recording mode switch included in the operation switch 105. In the present embodiment, the video camera 100 can record image data on a DVD-RW disk. If a user again operates the relay recording mode switch, the relay recording mode can be cancelled.

FIG. 2 is a flowchart illustrating an exemplary operation of the video camera 100 in the relay recording mode. The CPU 111 controls various sections of the video camera 100 to realize the processing illustrated in FIG. 2.

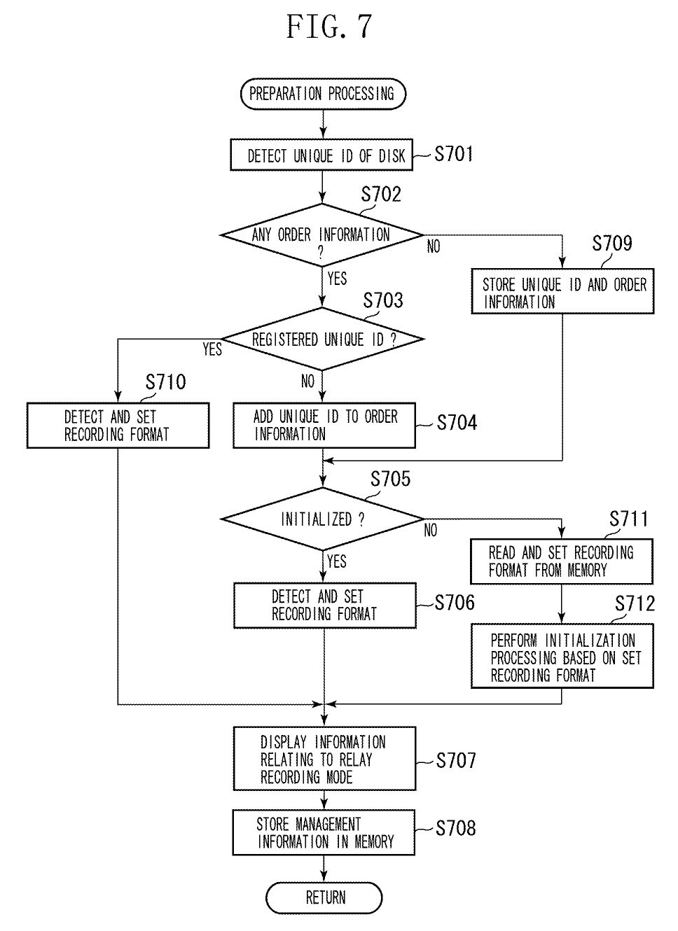

If a user operates the relay recording mode switch in a power-on state, the CPU 111 starts the processing flow illustrated in FIG. 2. In step S201, the CPU 111 executes preparation processing for the relay recording mode. FIG. 7 is a flowchart illustrating exemplary preparation processing performed in the relay recording mode.

In step S701, the CPU 111 detects, via the disk I/F 110, a unique ID of a disk which is recorded in a predetermined area of the disk 109. The CPU 111 writes the detected unique ID to the flash memory 113. In step S702, the CPU 111 determines whether any order information is stored in the flash memory 113. The order information indicates the order of each disk that stores part of the sequential image data recorded based on the relay recording mode.

The order information may not be stored if the disk is the first disk loaded after the relay recording mode switch has been operated by a user. If the CPU 111 determines that no order information is stored (NO in step S702), the processing flow proceeds to step S709.

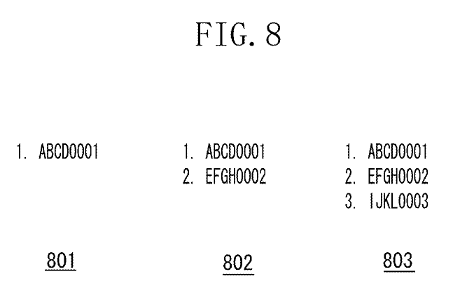

In step S709, the CPU 111 generates order information based on the unique ID detected in step S701 and stores the generated order information in the flash memory 113. FIG. 8 illustrates exemplary order information 801 generated in response to setting of the relay recording mode. The order information 801 includes a number indicating the order of each disk and a unique ID of the disk (e.g., ABCD0001).

If the flash memory 113 already stores the order information (YES in step S702), the processing flow proceeds to step S703. In step S703, the CPU 111 determines whether the unique ID detected in step S701 is already registered (described) in the order information. If the unique ID is not yet registered in the order information (NO in step S703), the CPU 111 determines that a new disk has been loaded.

In step S704, the CPU 111 adds the detected unique ID to the order information to update the contents of the order information. FIG. 8 illustrates exemplary order information 802 generated (updated) when the second disk has been loaded. The secondly loaded disk has a unique ID represented by EFGH0002. Similarly, FIG. 8 illustrates exemplary order information 803 generated (updated) when the third disk has been loaded. The thirdly loaded disk has a unique ID represented by IJKL0003. In this manner, the order information can include a numerical value representing the order of a disk and the ID information of the disk.

In step S705, the CPU 111 determines whether a currently loaded disk is already initialized. If the disk is the first disk after the relay recording mode switch has been operated by a user, the CPU 111 determines that the disk is already initialized (YES in step S705) If the CPU 111 determines that a disk is newly loaded, then the CPU 111 also determines in step S705 whether the newly loaded disk is already initialized.

If the CPU 111 determines that the disk is already initialized (YES in step S705), then in step S706, the CPU 111 detects a recording format based on the management information of the disk and sets the detected recording format as corresponding to the disk.

If the CPU 111 determines that the disk is not yet initialized (NO in step S705), then in step S711, the CPU 111 reads recording format information from the flash memory 113 and sets the read recording format as corresponding to the disk. Then, in step S712, the video camera 100 performs initialization processing for the disk based on the set recording format.

In other words, the video camera 100 applies the initialization processing to an uninitialized (unrecorded) disk based on the recording format of a preceding disk. Thus, a user is not required to select a recording format for the newly loaded disk on the selection screen of the video camera 100.

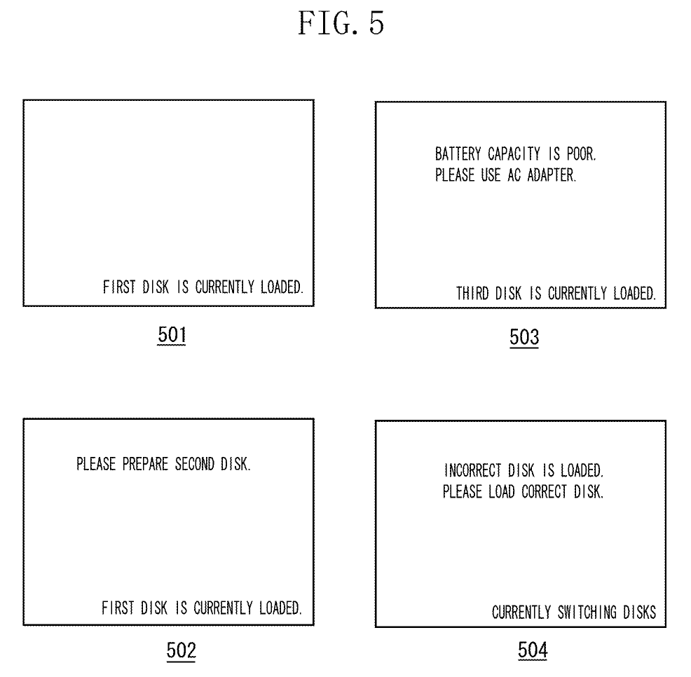

After the recording format setting processing is completed, the processing flow proceeds to step S707. In step S707, the CPU 111 causes the display unit 106 to display information relating to the relay recording mode. FIG. 5 illustrates exemplary information that the display unit 106 can display in the relay recording mode. More specifically, if the disk is the first loaded disk, the display unit 106 displays a message 501 that simply indicates the order of the disk.

In step S708, the CPU 111 generates management information for the disk 109. The flash memory 113 stores the generated management information. In addition, after the relay recording mode is set, or after a disk is newly loaded, the CPU 111 reserves a recording area on the disk 109 that can record moving image data produced according to the relay recording mode.

If the CPU 111 determines that the unique ID is already registered in the order information (YES in step S703), the processing flow proceeds to step S710. In step S710, the CPU 111 detects a recording format of the disk 109 (i.e., DVD-Video format or VR format) based on the management information of the disk and sets the detected recording format as corresponding to the disk. Then, the processing flow proceeds to step S707.

After the above-described preparation processing is terminated, the processing flow proceeds to step S202 (FIG. 2). In step S202, the CPU 111 determines whether a recording instruction is input via the operation switch 105. If the CPU 111 determines that a recording start instruction is input (YES in step S202), the processing flow proceeds to step S203.

In step S203, the video camera 100 records the generated moving image data on the disk 109 as described above. Namely, the video camera 100 records the moving image data based on the recording format and the image quality mode that have been set in the preparation processing.

In step S204, the CPU 111 detects a remaining recording capacity of the disk 109 based on the management information recorded on the disk 109. The CPU 111 determines whether the detected remaining recording capacity is equal to or less than a predetermined amount.

The predetermined amount in step S204 is a data amount corresponding to a predetermined remaining time (minutes) recordable on the disk 109 at an image quality mode (data rate) currently selected. Therefore, the predetermined amount in step S204 is variable depending on the image quality mode. However, the CPU 111 can refer to a constant threshold value regardless of the selected image quality mode, if acceptable, to check the remaining recording capacity of a disk.

If the CPU 111 determines that the remaining recording capacity is equal to or less than the predetermined amount (YES in step S204), the processing flow proceeds to step S205. In step S205, the CPU 111 causes the display unit 106 to display warning information to indicate a situation where the remaining recording capacity is insufficient.

FIG. 5 illustrates an exemplary message (warning information) 502 that the display unit 106 displays when the remaining recording capacity of the first loaded disk becomes insufficient during a recording operation of the disk.

In step S206, the CPU 111 determines whether the disk 109 has any remaining recording capacity. If the CPU 111 determines that there is any remaining recording capacity (YES in step S206), the processing flow proceeds to step S207. In step S207, the CPU 111 determines whether a recording stop instruction is input via the operation switch 105. If the CPU 111 determines that no recording stop instruction is input (NO in step S207), the processing flow returns to step S203 to continue the recording operation.

If the CPU 111 determines that a recording stop instruction is input (YES in step S207), the processing flow proceeds to step S208. In step S208, the video camera 100 stops recording image data on the disk 109. Then, in step S209, the CPU 111 updates the management information of the disk 109 stored in the flash memory 113.

Next, in step S210, the CPU 111 determines whether a relay recording mode cancel instruction is input via the operation switch 105. If the CPU 111 determines that a relay recording mode cancel instruction is input (YES in step S210), flow proceeds to step S215. In step S215, the CPU 111 executes the order information recording processing in the relay recording mode as described below.

If the CPU 111 determines that no relay recording mode cancel instruction is input (NO in step S210), the processing flow returns to step S211. In step S211, the CPU 111 determines whether an ejection instruction for the disk 109 is input via the operation switch 105. If the CPU 111 determines that a disk ejection instruction is input (YES in step S211), the processing flow proceeds to step S212.

In step S212, the CPU 111 causes the ejection mechanism (not shown) to unload the disk 109 from the video camera 100. In this case, if the disk has no remaining recording capacity, the CPU 111 can cause the display unit 106 to display an exemplary message (warning information) to prompt a user to load a new disk.

Next, in step S213, the CPU 111 determines whether a new disk 109 has been loaded. If the CPU 111 determines that a new disk 109 has been loaded (YES in step S213), the processing flow returns to step S201 to execute the preparation processing. If no disk is newly loaded (NO in step S213), the processing flow proceeds to step S214.

In step S214, the CPU 111 determines whether a power-off instruction is input via the operation switch 105. If the CPU 111 determines that a power-off instruction is input (YES in step S214), the CPU 111 stores, in the flash memory 113, the information indicating a state where the video camera 100 is currently operating in the relay recording mode and turns the power source off.

If the CPU 111 determines that no disk ejection instruction is input (NO in step S211), the CPU 111 proceeds to step S218. In step S218, the CPU 111 determines whether a power-off instruction is input via the operation switch 105. If the CPU 111 determines that a power-off instruction is input (YES in step S218), the CPU 111 stores, in the flash memory 113, the information indicating a state where the video camera 100 is currently operating according to the relay recording mode and turns the power source off.

If in step S206 the CPU 111 determines that the disk 109 has no remaining recording capacity for recording image data (NO in step S206), the processing flow proceeds to step S216. In step S216, the video camera 100 stops recording image data on the disk 109. Then, in step S217, the CPU 111 updates the management information of the disk 109 stored in the flash memory 113. Then, the processing flow proceeds to step S212 to eject the disk 109.

As described above with reference to FIG. 2, if a newly loaded disk is not yet initialized, the video camera 10 performs the initialization processing for the disk based on the recording format stored in the flash memory 113. Namely, the video camera 10 can apply the initialization processing to a newly loaded disk (i.e., uninitialized or unrecorded disk) based on the recording format applied to a preceding disk loaded immediately before the uninitialized or unrecorded disk is loaded.

The video camera 10 can generate order information that correlates the recording (loading) order of each disk recorded according to the relay recording mode with a unique ID of the disk and can store the generated order information in the flash memory 113.

Next, the order information recording processing performed in step S215 is described below. For example, it is now assumed that the video camera 10 has recorded image data on three disks according to the relay recording mode before a relay recording mode cancel instruction is input by a user via the operation switch 105.

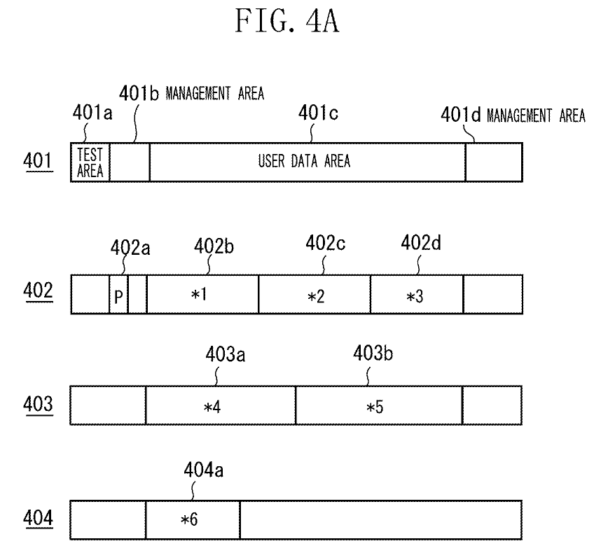

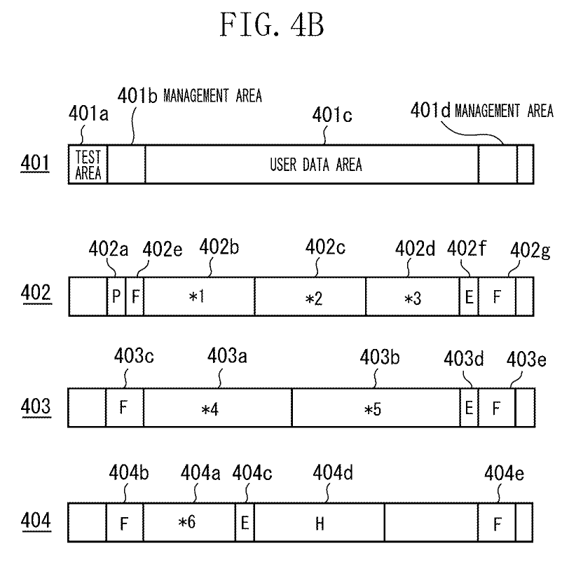

FIGS. 4A and 4B illustrate exemplary recording states of three disks that store image data recorded according to the relay recording mode.

The disk 109 (refer to 401 illustrated in FIG. 4A) includes a recording area 401a (header) that stores light beam power adjustment data, a recording area 401b that stores management information, a recording area 401c that stores user data including image data and audio data, and a recording area 401d (tail) that stores management information.

As illustrated in FIG. 4A, an exemplary recording of image data according to the relay recording mode ranges from first to third disks (refer to 402 through 404) in a condition where the recorded image data has not yet been subjected to the finalization processing.

The first disk (refer to 402 illustrated in FIG. 4A) includes a management information area 402a which is first recorded when the relay recording mode is set, in addition to plural data areas 402b, 402c, and 402d that store moving image data *1 through *3, respectively.

The second disk (refer to 403 illustrated in FIG. 4A) includes two data areas 403a and 403b that store moving image data *4 and *5. The third disk (refer to 404 illustrated in FIG. 4A) includes a data area 404a that stores moving image data *6.

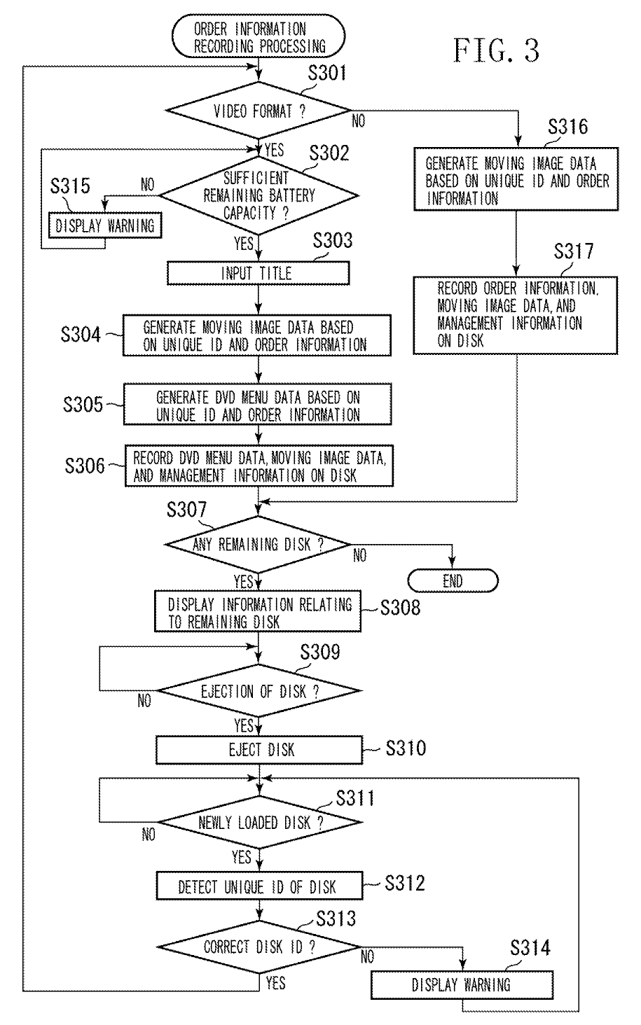

FIG. 3 is a flowchart illustrating exemplary order information recording processing. The CPU 111 controls various sections to execute the order information recording processing illustrated in FIG. 3.

In step S301, the CPU 111 determines whether a recording format of a currently loaded disk is DVD-Video format. If the CPU 111 determines that the recording format is the DVD-Video format (YES in step S301), the video camera 100 applies the finalization processing to the disk so that other DVD players can perform a playback operation for a disk storing image data recorded based on the DVD-Video format.

The time required to complete the finalization processing varies depending on the amount of data recorded in a disk. Hence, before the finalization processing is performed, in step S302, the CPU 111 determines whether a remaining battery capacity is sufficient for completing the finalization processing. If the remaining battery capacity is poor (NO in step S302), then in step S315, the CPU 111 causes the display unit 106 to display warning information 503 illustrated in FIG. 5 and waits until a new battery is loaded or an AC power source is supplied.

If the CPU 111 determines that the remaining battery capacity is sufficient (YES in step S302), the processing flow proceeds to step S303. In step S303, a user can input a desired DVD title name on a DVD menu. For example, a user inputs “sports meeting.”

Next, the CPU 111 identifies the order of a currently loaded disk based on the unique ID information of the currently loaded disk (detected in the preparation processing illustrated in FIG. 7) and the order information stored in the flash memory 113. Then, in step S304, the CPU 111 causes the image processing circuit 114 and the moving image coding/decoding circuit 108 to generate moving image data indicating a preceding or succeeding disk.

For example, if the finalization processing is applied to the third disk, the image processing circuit 114 and the moving image coding/decoding circuit 108 can generate moving image data indicating a message “Please playback the second disk.” Moreover, if the finalization processing is applied to the second disk, the image processing circuit 114 and the moving image coding/decoding circuit 108 can generate moving image data indicating a message “Please playback the first disk” or “Please playback the third disk.”

Next, in step S305, the CPU 111 generates menu data based on the unique ID of the currently loaded disk and the order information. More specifically, the CPU 111 generates image data for a menu screen including a thumbnail of moving image data recorded in the currently loaded disk, a thumbnail of moving image data recorded in a preceding or succeeding disk, and the title input in step S303.

In this case, the menu data generated by the CPU 111 includes information for correlating each thumbnail with recorded moving image data. Furthermore, the menu screen according to the present embodiment includes text information indicating the total number of disks storing the current moving image data recorded based on the relay recording mode and the order of the currently loaded disk.

Next, in step S306, the video camera 100 records the DVD menu data, the moving image data, and the management information (i.e., information for managing the data recorded on the disk) on predetermined areas of the disk 109. FIGS. 4A and 4B illustrate exemplary recording areas for the data.

If the CPU 111 determines that the recording format is the VR format (NO in step S301), the processing flow proceeds to step S316. In step S316, the CPU 111 identifies the order of a currently loaded disk based on the unique ID of the disk and the order information stored in the flash memory 113. Then, the CPU 111 generates moving image data indicating a preceding or succeeding disk as described above Next, in step S317, the video camera 100 records the order information, the generated moving image data, and the management information (i.e., information for managing the data recorded on the disk) on predetermined areas of the disk 109, If the above-described processing is completed for one disk, the CPU 111 stores, in the flash memory 113, the unique ID of the disk as a disk ID having been subjected to the finalization processing.

Then, in step S307, the CPU 111 determines whether there is any disk that stores image data recorded according to the relay recording mode and has not yet been subjected to the recording processing for the order information, based on the order information stored in the flash memory 113. If the CPU 111 determines that all disks have been already subjected to the recording processing for the order information (NO in step S307), the CPU 111 deletes the order information and the disk ID of each processed disk from the flash memory 113 and terminates the processing of this routine.

If the CPU 111 determines that there is a disk having not been subjected to the recording processing for the order information (YES in step S307), the processing flow proceeds to step S308. In step S308, the CPU 111 detects the number of remaining disks based on the order information stored in the flash memory 113 and causes the display unit 106 to display the information indicating the remaining disks.

Subsequently, in step S309, the CPU 111 determines whether an ejection instruction for the disk is input. If the ejection instruction is input (YES in step S309), the CPU 111 causes the ejection mechanism (not shown) to unload the disk (step S310). Then, in step S311, the CPU 111 determines whether another disk is loaded. If a disk is newly loaded (YES in step S311), then in step S312, the CPU 111 detects a unique ID of the newly loaded disk.

Next, in step S313, the CPU 111 determines whether the detected unique ID is involved in the order information stored in the flash memory 113 and determines whether the order information is already recorded in the disk. If the detected unique ID of the newly loaded disk is not involved in the order information, or if the order information is already recorded in the disk (NO in step S313), the processing flow proceeds to step S314. In step S314, the CPU 111 causes the display unit 106 to display a warning message 504 illustrated in FIG. 5. Then, the processing flow returns to step S311.

If the detected unique ID of the newly loaded disk is involved in the order information, and if the disk has not been subjected to the order information recording processing (YES in step S313), the processing flow returns to step S301 to execute the above-described processing.

FIG. 4B illustrates exemplary recording states of the disks at the moment the order information recording processing for all disks recorded according to the relay recording mode is terminated. In FIG. 4B, recording states 402 to 404 illustrate data areas on three disks recorded according to the relay recording mode in a state where the order information recording processing has been completed.

The video camera 100 can record the management information F based on the DVD-Video format in areas 402e, 402g, 403c, 403e, 404b, and 404e of three disks. Furthermore, the video camera 100 can record moving image data indicating a preceding or succeeding disk in areas 402f, 403d, and 404c and record dummy data based on the DVD-Video format in an area 404d.

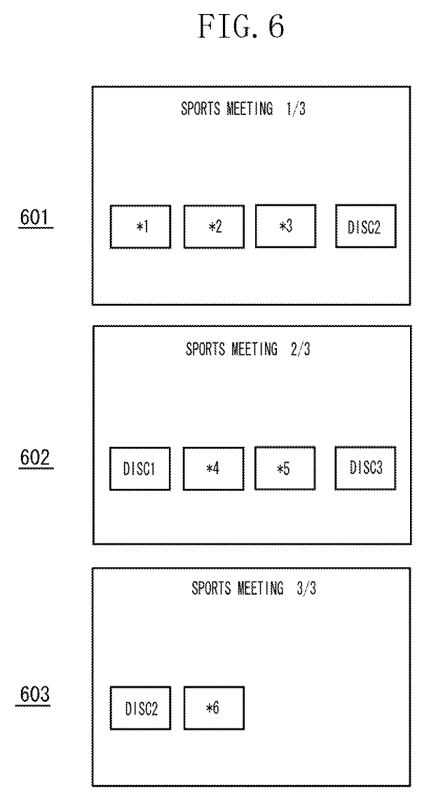

FIG. 6 illustrates menu screens for three disks which are recorded according to the relay recording mode based on the DVD-Video format and subjected to the finalization processing as described above. The exemplary menu screens illustrated in FIG. 6 can be displayed when each disk is played back in a DVD player.

As illustrated in FIG. 6, a title “sports meeting” input by a user can be displayed on the menu screen. A menu screen 601 for the first disk includes thumbnails *1 to *3 indicating three moving image scenes recorded in the disk and a thumbnail “DISC2” indicating the next disk. If a user selects one of the thumbnails *1 to *3, the video camera 100 can start a playback operation for the moving image data of the selected scene.

If a user selects the thumbnail “DISC2”, the video camera 100 can read the moving image data relating to the next disk from the data area 402f illustrated in FIG. 4B. For example, the video camera 100 displays a message “Please insert DISC2.”

The menu screen illustrated in FIG. 6 includes additional information relating to the total number of disks recorded according to the relay recording mode and the order of each disk. For example, the menu screen 601 for the first disk includes additional information “⅓” according to which a user can easily know that there are three disks which have the same title “sports meeting” and store sequential image data recorded according to the relay recording mode. Furthermore, the user can know the order of each disk. A menu screen 602 for the second disk includes thumbnails *4 and *5 representing two moving image scenes recorded in the second disk, a thumbnail “DISCL” representing the previous disk, and a thumbnail “DISC3” representing the next disk. A menu screen 603 for the third disk includes a thumbnail *6 representing a moving image scene recorded in the third disk and a thumbnail “DISC2” representing the previous disk.

In the present embodiment, instead of recording the moving image data for the message “Please insert DISC2”, the video camera 100 can display a still image representing a corresponding character string. Moreover, the processing in step S701 (FIG. 7) can be modified so as to detect information relating to the manufacturer of a disk and store the detected manufacturer information together with the unique ID of the disk in the flash memory 113. The manufacturer information can be included in a menu screen when a disk is subjected to the finalization processing and can be recorded on the disk. Moreover, the disk ID can include multiple information, such as a combination of a manufacturing number and a manufacturer name of the disk.

As described above, if an unrecorded disk is newly loaded in the relay recording mode, the present embodiment can automatically perform the initialization processing for the newly loaded disk based on the recording format that has been applied to a preceding disk and stored in the flash memory. Accordingly, a user is not required to perform recording format setting processing every time an uninitialized or unrecorded disk is loaded. Thus, a user can promptly start a shooting operation. On the other hand, a user can arbitrarily select a recording format for an unrecorded disk in a situation where the video camera is not operating in the relay recording mode.

Therefore, based on a menu of each disk, a user can easily recognize the total number of disks belonging to the same group and the order of each disk. The exemplary embodiment is not limited to the above-described finalization processing that requires a user to input a DVD title name. If desirable, at the timing the relay recording mode is set, a user can input a name for a disk group to be recorded according to the set relay recording mode.

Moreover, the exemplary embodiment is not limited to the above-described video camera having the recording/playback capability applicable to a DVD or other optical disk. For example, the present embodiment can be similarly implemented even if the optical disk is replaced with another type of recording medium such as a memory card or a magnetic disk.

If memory cards are used, no DVD menu screen is available. Therefore, the order information can be stored in a management file of the card. In a playback operation, the display unit can display the order of cards belonging to a group and the total number of cards based on the order information.

Each unit of the recording apparatus and each step of the recording method in the above-described exemplary embodiments of the present invention can be realized by a computer that can execute a program stored in a RAM or a ROM. Thus, the present invention encompasses program code and a computer-readable medium storing the program code.

The present invention can be implemented as a system, an apparatus, a method, a program or a storage medium. More specifically, the present invention can be applied to a system including plural devices or can be applied to a single apparatus.

Furthermore, software program code for realizing the functions of the above-described exemplary embodiments (i.e., program code corresponding to the flowcharts illustrated in FIGS. 2 and 3) can be supplied to a system or an apparatus including various devices. A computer (or CPU or micro-processing unit (MPU)) in the system or the apparatus can execute the program to operate the devices to realize the functions of the above-described exemplary embodiments. Accordingly, the present invention encompasses program code supplied from a remote place and installable in a computer when the functions or processes of the exemplary embodiments can be realized by the computer.

In this case, the program code itself can realize the functions of the exemplary embodiments. The equivalents of programs can be used if they possess comparable functions. Furthermore, the present invention encompasses supplying the program code to a computer with a storage (or recording) medium storing the program code. In this case, the type of program can be any one of object code, interpreter program, and OS script data. A storage medium supplying the program can be selected from any one of a floppy disk, a hard disk, an optical disk, a magneto-optical (MO) disk, a compact disc—ROM (CD-ROM), a CD-recordable (CD-R), a CD-rewritable (CD-RW), a magnetic tape, a nonvolatile memory card, a ROM, and a DVD (DVD-ROM, DVD-R)

The method for supplying the program includes accessing a web site on the Internet using the browsing function of a client computer, when the web site allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different web sites. Namely, the present invention encompasses WWW servers that allow numerous users to download the program files so that the functions or processes of the present invention can be realized on their computers.

Enciphering the programs of the present invention and storing the enciphered programs on a CD-ROM or comparable recording medium is an exemplary method when the programs of the present invention are distributed to the users. The authorized users (i.e., users satisfying predetermined conditions) are allowed to download key information from a page on the Internet. The users can decipher the programs with the obtained key information and can install the programs on their computers. When the computer reads and executes the installed programs, the functions of the above-described exemplary embodiments can be realized.

Moreover, an operating system (OS) or other application software running on the computer can execute part or all of the actual processing based on instructions of the programs.

Additionally, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2006-130099 filed May 9, 2006 and No. 2007-103092 filed Apr. 10, 2007, which are hereby incorporated by reference herein in their entirety.

What is claimed is:

1. A recording apparatus comprising:
a recording format selection unit configured to select one of a plurality of recording formats;
an initialization unit configured to initialize a loaded recording medium based on a recording format selected by the recording format selection unit;
a recording unit configured to record image data on the loaded recording medium;
a storage unit configured to store a recording format type of the loaded recording medium; and
a control unit configured to control the initialization unit to initialize a newly loaded recording medium, if loaded after a preceding recording medium, based on a recording format type of the preceding recording medium stored in the storage unit and to control the recording unit to record image data on the initialized loaded recording medium based on the recording format type of the preceding recording medium stored in the storage unit.

2. The recording apparatus according to claim 1, further comprising a mode switching unit configured to switch between an ordinary recording mode and a relay recording mode,
wherein the control unit controls the initialization unit to initialize an uninitialized recording medium based on a recording format type selected by the recording format selection unit when the ordinary recording mode is selected by the mode switching unit, and the control unit controls the initialization unit to initialize an uninitialized recording medium based on the recording format type stored in the storage unit when the relay recording mode is selected by the mode switching unit.

3. The recording apparatus according to claim 2, wherein, when the relay recording mode is selected by the mode switching unit, the storage unit stores a recording format type of the preceding recording medium, and the control unit controls the initialization unit to initialize the newly loaded recording medium, if loaded after the preceding recording medium, based on the recording format type stored in the storage unit.

4. The recording apparatus according to claim 2, further comprising a display unit configured to display a selection screen for selecting between recording formats,
wherein the recording format selection unit is configured to select a recording format using the selection screen, and
wherein the control unit controls the display unit to display the selection screen if an uninitialized recording medium is loaded when the ordinary recording mode is selected and to inhibit displaying the selection screen, regardless of whether the uninitialized recording medium is loaded, when the relay recording mode is selected.

5. The recording apparatus according to claim 1, further comprising:
a determination unit configured to determine whether the newly loaded recording medium is already initialized; and
a recording format detection unit configured to detect a recording format of a recording medium that has been determined by the determination unit to be already initialized,
wherein, if the newly loaded recording medium is already initialized, the control unit controls the recording unit to record image data based on the recording format detected by the recording format detection unit.

6. A recording apparatus comprising:
a recording format selection unit configured to select one of a plurality of recording formats;
an initialization unit configured to initialize a loaded recording medium;
a recording unit configured to record image data on the loaded recording medium; and
a mode switching unit configured to switch between an ordinary recording mode that enables the initialization unit to initialize a newly loaded recording medium based on a recording format selected by the selection unit independent of a recording format selected for a preceding recording medium and a relay recording mode that enables the initialization unit to initialize a newly loaded recording medium, if loaded after a preceding recording medium, based on a recording format selected for the preceding recording medium.

7. A method comprising:
selecting one of a plurality of recording formats;
initializing a loaded recording medium based on a selected recording format;
recording image data on the loaded recording medium;
storing a recording format type of the loaded recording medium;
initializing a newly loaded recording medium, if loaded after a preceding recording medium, based on a stored recording format type of the preceding recording medium; and
recording image data on the initialized recording medium based on the recording format type of the preceding recording medium.

8. A computer-readable storage medium storing computer-executable process steps, the computer-executable process steps causing a computer to execute the method of claim 7.

9. A method comprising:
selecting one of a plurality of recording formats;
initializing a loaded recording medium;
recording image data on the loaded recording medium; and
switching between an ordinary recording mode for initializing a newly loaded recording medium based on a recording format selected independent of a recording format selected for a preceding recording medium and a relay recording mode for initializing a newly loaded recording medium, if loaded after a preceding recording medium, based on a recording format selected for the preceding recording medium.

10. A computer-readable storage medium storing computer-executable process steps, the computer-executable process steps causing a computer to execute the method of claim 9.
